(19) United States
(12) Patent Application Publication
(10) Pub. No.: US 2026/0299917 A1
(43) Pub. Date: Oct. 1, 2026

(54) Apparatus for controlling firmware update time interval and method for controlling firmware update

(71) Applicant: PixArt Imaging Inc., Hsin-Chu City (TW)

(72) Inventors: Chien-Zhi Wang, Hsin-Chu City (TW); Jr-Yi Li, Hsin-Chu City (TW)

(73) Assignee: PixArt Imaging Inc., Hsin-Chu City (TW)

(21) Appl. No.: 19/091,805

(22) Filed: Mar. 26, 2025

(51) Int. Cl. G06F 8/65

(52) U.S. Cl. CPC G06F 8/65

(57) ABSTRACT

The present invention provides an apparatus for controlling firmware update time interval, the apparatus includes a sending module for sending a plurality of data commands and a plurality of read-back commands, a judging module for receiving a read-back signal after one of the data command and the corresponding read-back command were sent, and for judging whether the read-back signal is correct, and a timing control module, which adjusts a time interval between the subsequent data command and the read-back command according to the result of the judging module.

### BACKGROUND OF THE INVENTION

### 1. Field of the Invention

The invention provides an innovative firmware update control method, aiming at improving the reliability and efficiency of firmware update. By dynamically adjusting the time interval between each data command, especially dynamically adjust the data command and the responding read-back command, the invention can adaptively optimize the update process according to the actual operating condition of the system, so as to ensure the success rate of firmware update.

### 2. Description of the Prior Art

Firmware updates are a crucial part of ensuring that electronic products continue to function and provide optimal performance. The traditional single writing writes one bit into the memory at a time. Although the single writing is stable, the update speed is slow, which cannot meet the demand of modern electronic products for rapid update. In order to improve the update efficiency, burst writing came into being. Burst writing writes multiple bits (for example, 256 bits) into the memory at one time, which greatly shortens the update time. However, burst writing also has some disadvantages. First, the control of writing time is a very challenging problem. If the writing time is too short, the memory update step may not be completed, resulting in data damage or incompleteness. Conversely, if the writing time is too long, it will not only slow down the update speed, but also increase the power consumption of the system.

Secondly, error detection and correction is also a problem that cannot be ignored. Burst writing brings a higher data error rate. If there is no effective error detection mechanism, it may lead to firmware update failure and even system crash. Thirdly, the stability of the system is also an important consideration. Burst writes place high demands on the system's timing. If the timing control is improper, it will easily lead to data writing errors or system crashes. In addition, during the update process, if the system is disturbed, the update may also fail. In a word, although burst writing can greatly improve the firmware update speed, its technical implementation still faces many challenges. How to balance speed, reliability, and security is the direction that firmware engineers continue to strive for.

### SUMMARY OF THE INVENTION

The present invention provides an apparatus for controlling firmware update time interval, the apparatus includes a sending module for sending a plurality of data commands and a plurality of read-back commands, a judging module for receiving a read-back signal after one of the data command and the corresponding read-back command were sent, and for judging whether the read-back signal is correct, and a timing control module, which adjusts a time interval between the subsequent data command and the read-back command according to the result of the judging module.

The present invention further provides a method for controlling firmware update, the method includes the following steps: sending a first data command, sending a first read-back command after a first time interval T1 to receive a read-back signal, judging whether that read-back signal is correct, when the read-back signal is correct, a second data command is subsequently sent, and a second read-back command is sent after a second time interval T2, wherein the second time interval T2 is less than or equal to the first time interval T1, when the read-back signal is incorrect, the first data command is re-sent subsequently, and a third read-back command is sent after a third time interval T3, wherein the third time interval T3 is greater than the first time interval T1.

The present invention provides an apparatus for controlling the firmware update time interval and a firmware update method. The invention is characterized in that in the firmware update procedure, the time interval of the update step (that is, the time interval between sending a data command and sending a corresponding read-back command) is dynamically adjusted. More specifically, after the update step is successful, the time interval of the next update step is shortened or maintained, and if the update step fails, the time interval of the next update step is extended. By dynamically adjusting the time interval, the total time of firmware update procedure can be reduced and the success rate of firmware update procedure can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a block diagram of an apparatus for controlling time interval of firmware update according to the present invention.

FIG. 2 shows a flowchart of the firmware update procedure of the present invention.

FIG. 3 shows a timing chart for adjusting the time interval between the next data command and the read-back command (that is, the time interval of the next update step) when the judging module judges that a read-back signal is correct.

FIG. 4 shows a timing chart for adjusting the time interval between the next data command and the read-back command (that is, the time interval of the next update step) when the judging module judges that a read-back signal is incorrect.

### DETAILED DESCRIPTION

In the following descriptions, several embodiments are provided to explain the concept of the present application. It will be appreciated that the term “first”, “second”, “third” in following descriptions are only for the purpose of distinguishing different one elements, and do not mean the sequence of the elements. For example, a first device and a second device only mean these devices can have the same structure but are different devices.

As mentioned above, writing data into the memory module by burst writing method is helpful to improve the writing speed, but it also increases the possibility of writing failure. Therefore, the present invention provides an apparatus for controlling the firmware update time interval, which helps to reduce the firmware update procedure time and improve the success rate of firmware update. Details are described in the following paragraphs.

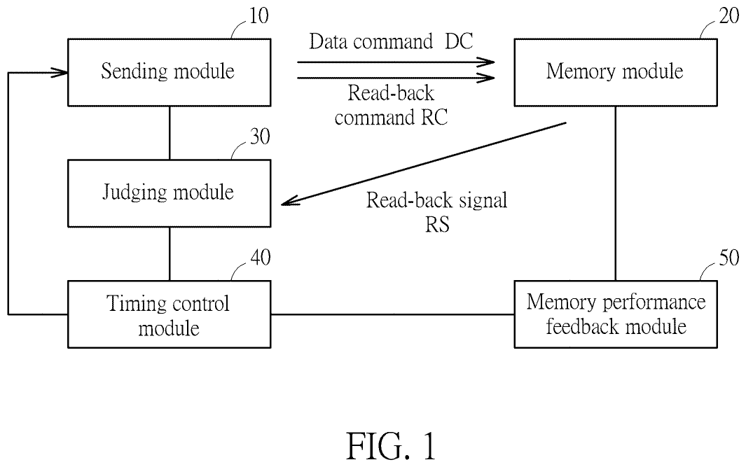

FIG. 1 shows a block diagram of an apparatus for controlling time interval of firmware update according to the present invention. This apparatus mainly comprises a sending module 10, a memory module 20, a judging module 30, a timing control module 40 and a memory performance feedback module 50.

The sending module 10 is responsible for sending various commands to the memory module 20, including sending multiple data commands DC and multiple read-back commands RC. The “update step” described in the following paragraphs refer to a data command DC and a read-back command RC, and the whole firmware update procedure contains multiple update steps. When the firmware needs to be updated, the sending module 10 will send these commands in sequence according to the time interval set by the timing control module 40 to start the firmware update procedure.

The memory module 20 is a place where firmware is stored. It receives commands from the sending module 10 and performs corresponding writing or reading operations. When receiving the data commands DC, the memory module 20 will store the new firmware data in the designated memory address, overwriting the old firmware data. When receiving the read-back commands RC, the memory module 20 will send the stored data back to the judging module 30 for data verification.

The judging module 30 is responsible for checking the data returned by the memory module 20 to confirm whether the update step is successful. The judging module 30 will compare the read data with the original data expected to be written bit by bit. If they are consistent, it means that the writing process (the update step) is successful. Otherwise, if the returned data is not the same as the original data, it means that an error has occurred in the updating process. The judgment result of the judgment module 30 will directly affect the time interval between the next update step (the next data command and the read-back command). In addition, the “read data and original data expected to be written are the same” here refers to the same content, the same number of bits, or other verification methods approved by the manufacturer, and the invention is not limited to this.

The timing control module 40 dynamically adjusts the time interval between each data command and the next data command, especially dynamically adjusts the time interval between the data command and the corresponding read-back command according to the feedback information provided by the judging module 30. If the previous update step is successful, it means that the writing time of the memory is enough and there is no error. At this time, the timing control module 40 can appropriately shorten the time interval between the next data command and the read-back command to increase the overall update speed. On the other hand, if the previous update step fails, it indicates that there may be a problem in the memory or that the writing time is not enough, resulting in data error. At this time, the timing control module 40 will extend the time interval between the next data command and the read-back command to improve the success rate of the step of writing data.

The memory performance feedback module 50 continuously monitors the operating state of the memory, including the memory utilization rate, writing speed, error rate, etc. When the system is running multiple programs or needs to process a large amount of data, the utilization rate of memory will be greatly improved. At this time, the memory performance feedback module 50 will transmit the information that the memory is busy to the timing control module 40. After receiving this message, the timing control module 40 will adjust the time interval between each data command, especially dynamically adjusts the time interval between the data command and the corresponding read-back command to reduce the priority of firmware update, so as to avoid affecting other running programs and ensure the stability of the system.

Through the modules, the invention can accurately control the time interval of the firmware update procedure, effectively improve the stability and reliability of the firmware update procedure, and reduce the risk of update failure. In the following paragraphs, the firmware update procedure method of the present invention will be described in more detail.

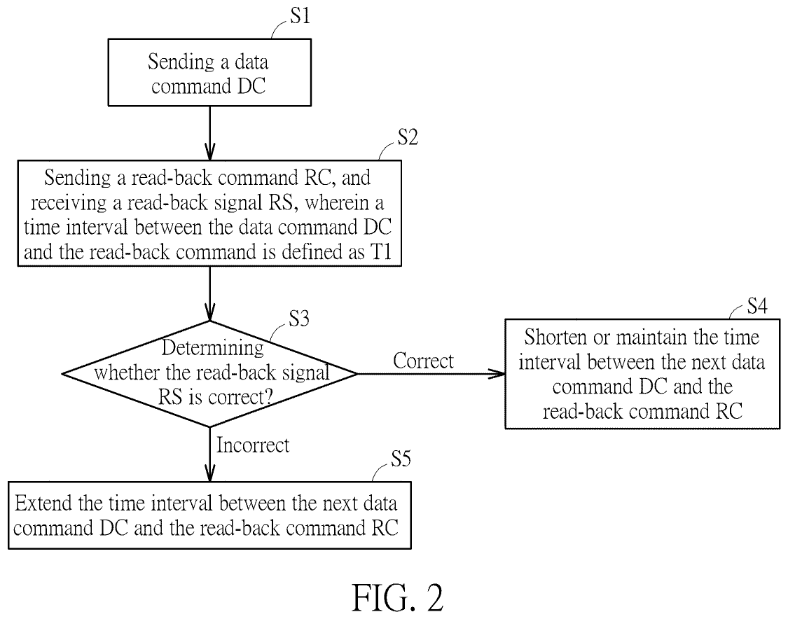

Please refer to FIG. 1 and FIG. 2. FIG. 2 shows a flowchart of the firmware update procedure of the present invention. In more detail, the method shown in FIG. 2 is a flowchart of firmware update using the apparatus of FIG. 1. The purpose of the method described in FIG. 2 is to ensure that the read-back signal is correct, and to adjust the time interval between the subsequent data command and the read-back command according to the judgment result, thereby reducing the firmware update speed.

First, performing step S1: sending a data command DC. In more detail, a data command DC can be sent to the memory module 20 by the sending module 10 of FIG. 1, so as to request that a plurality of data (e.g., 256 bits, but not limited to this) be written to a segment of address in the memory module 20.

Then, as shown in step S2, sending a read-back command RC, where the read-back command RC is sent to the memory module 20 by the sending module 10 in FIG. 1, for example, and the stored data is requested to be sent back to the judging module 30. It is worth noting that the data stored in the memory module 20 and sent back to the judging module 30 here is defined as the read-back signal RS, where the read-back signal RS is different from the read-back command RC. More specifically, the read-back command RC is sent from the sending module 10 to the memory module 20, and the read-back signal RS is sent back from the memory module 20 to the sending module 10. In addition, in the whole firmware update procedure, the time interval between each data command DC and the next data command DC is defined as TO. It is worth noting that there is no read-back command RC in the conventional firmware update procedure. Compared with the conventional procedure, the present invention adds the read-back command RC in one data command DC and the next data command DC to request the memory module 20 to return data. Here, the time interval between the data command DC and the read-back command RC is defined as T1, and the time interval between the read-back command RC and the next data command DC is defined as T1′, and the time interval TO includes the time interval T1 and the time interval T1′ It is worth noting that in the whole firmware update procedure, the sending module 10 will send a plurality of data commands DC and a plurality of corresponding read-back commands RC, where the time interval T1 refers to the time interval between a data command DC and its corresponding read-back command RC, and the time interval T1′ refers to the time interval between a read-back command RC and the next data command DC, that is, if a data command DC is sent, the read-back command RC reading the data command DC will be sent after time T1, and when a read-back command RC is sent, the next data command DC will be sent after time T1′. A more detailed explanation will be described in the following paragraphs.

Next, Step S3 is performed to determine whether the read-back signal RS is correct. If the judgment result in step S3 is correct, proceed to step S4: shorten or maintain the time interval T1 between the next data command DC and the read-back command RC. On the other hand, if the judgment result in step S3 is incorrect, then proceed to step S5: extend the time interval T1 between the next data command DC and the read-back command RC. The method for judging whether the read-back signal RS is correct is the same as above, that is, the data returned by the read-back signal RS and the data expected to be written by the data writing signal DC are compared bit by bit, and if they are consistent, the writing step is successful, that is, the read-back signal RS is correct. Otherwise, if the returned data is not the same as the original data, this means the read-back signal RS is incorrect. In addition, in the following embodiments, the time interval T1 will be dynamically adjusted (shortened or extended) mainly according to whether read-back signal RS is correct or not, while the time interval T1′ will remain unchanged, but the present invention is not limited to this. In other embodiments, the time interval T1′ may also be changed according to requirements, which is also within the scope of the present invention.

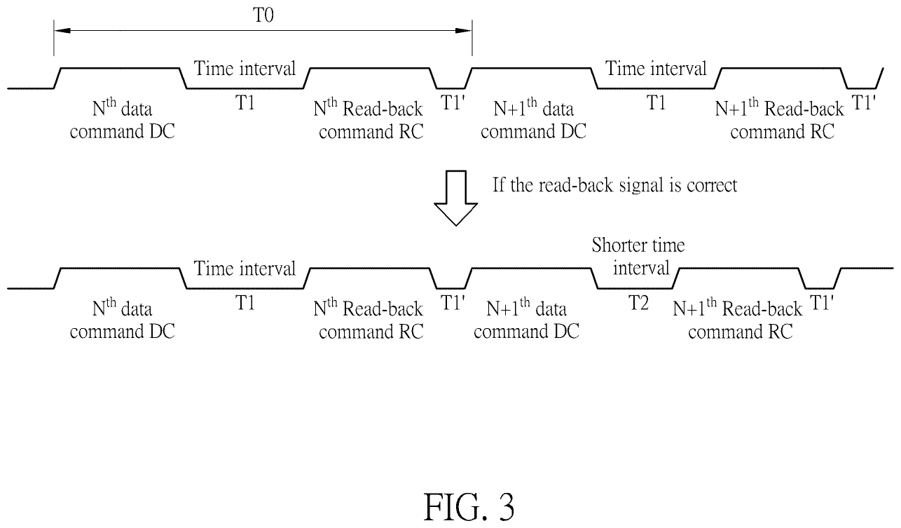

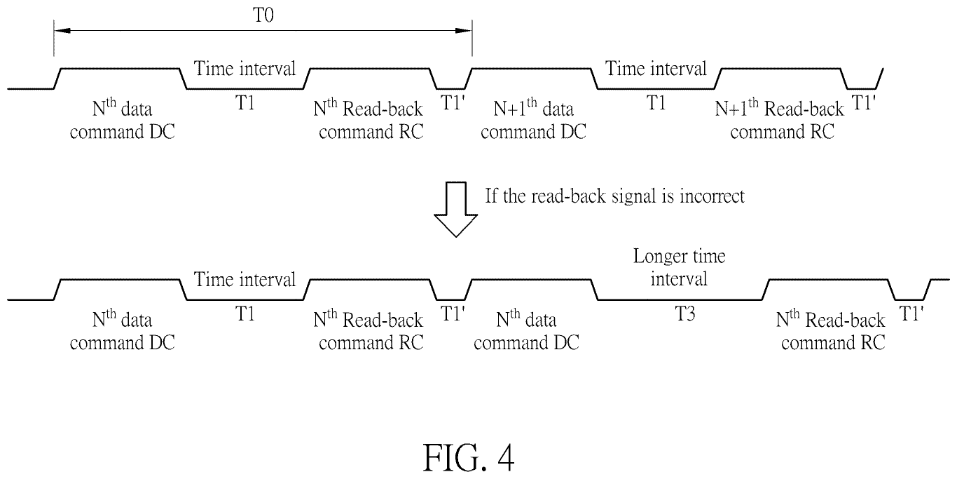

With regard to the above steps S4 and S5 in FIG. 2, further reference can be made to FIGS. 3 and 4, wherein FIG. 3 shows a timing chart for adjusting the time interval between the next data command and the read-back command (i.e. the time interval of the next update step) when the judging module judges that a read-back signal is correct. FIG. 4 shows a timing chart for adjusting the time interval between the next data command and the read-back command (that is, the time interval of the next update step) when the judging module judges that a read-back signal is incorrect.

As shown in FIG. 3, the timing diagram sequentially includes the data command DC sent for the n^{th} time and the read-back command RC for the n^{th} time, wherein the read-back command RC for the n^{th} time corresponds to the data command DC for the n^{th} time, that is, the read-back command RC requires the memory module to send back the data written by the data command DC. As shown in FIG. 3, the time interval between the n^{th} transmitted data command DC and the n^{th} read-back command RC is defined as T1.

Please continue to refer to FIG. 3. When the judging module judges that a read-back signal is correct, the time interval between the next data command DC and the read-back command RS is shortened. More specifically, when the judging module 30 judges that a read-back signal RS is correct, it means that the data predicted to be written into the memory module 20 has been successfully written, so the sending module 10 will send the next data command DC and the corresponding read-back command RC, that is, the data command DC of the n+1^{th} time and the read-back command of the n+1^{th} time, wherein the time interval between them is defined as T2, and the time interval T2 is preferably smaller than the time interval T1. For example, the time interval T1 can be subtracted by a time ΔT to become T2, that is, T2=T1−ΔT, or T1 can be multiplied by a value less than 1 to become T2, that is, T2=T1*m, where m<1. For example, T2/T1 can be ½, ⅔, ¾, etc., but it is not limited to this. In some embodiments, the ratio of T2 to T1 is greater than ½ and less than 1, but it is not limited to this. In other embodiments of the present invention, the ratio of T2 to T1 may be other values not greater than 1. That is to say, after this batch of data is successfully written into the memory module, the system will try to perform the next update step in a shorter time interval, which will help reduce the total time for firmware update. It is worth noting that after several update steps, the time interval may approach a stable value. At this time, if the difference between the time interval T2 and the time interval T1 is less than a set value, it means that the reduction in time interval T2 compared to T1 is no longer significant, so the time interval T2 can be set equal to the time interval T1, that is, T2=T1 or the ratio of T1 to T2 is 1, which is also within the scope of the present invention. Besides, in FIG. 3, in addition to changing the ratio of shortening the time interval T2 according to the requirements, the frequency of shortening the time interval can also be set. For example, in FIG. 3, the manufacturer can set the judging module 30 to judge that the read-back signal RS is correct for M consecutive times before shortening the next time interval. Such variations are also within the scope of the present invention.

Please refer to FIG. 4. When the judging module 30 judges that a read-back signal RS is incorrect, the time interval between the next data command DC and the read-back command RC is extended. In more detail, when the judging module 30 judges that a read-back signal RS is incorrect, the data predicted to be written into the memory module 20 has not been successfully written, so the sending module 10 will send the data command DC and the corresponding read-back command RC again, that is, resend the n^{th} data command DC and the n^{th} read-back command RC, wherein the time interval between them is defined as T3. Here, the time interval T3 is greater than the time interval T1. For example, by adding a time interval of ΔT to T1, the resulting time interval is T3, that is, T3=T1+ΔT, or it can be T3 by multiplying T1 by a value greater than 1, that is, T2=T1*n, where n>1. For example, T2/T1 can be 2, 2.5, 3.69, etc., but it is not limited to this. That is to say, when this batch of data fails to be written into the memory module 20, the system will try to perform the next update step at a longer time interval, so that the success rate of the next update step can be improved. It is worth noting that after each write failure, the time interval will gradually increase. When the time interval T3 is greater than a set value (for example, 50 seconds, but not limited to this), it means that the firmware update fails even after a long time interval. At this time, the system can determine that the update fails due to other reasons, so it can stop the firmware update step and send an update failure warning message to remind the user that the firmware update procedure is not completed. Besides, in FIG. 4, in addition to changing the increase ratio of the time interval T3 according to requirements, the frequency of increasing the time interval can also be set. For example, in FIG. 4, the manufacturer can set the judging module 30 to judge that the read-back signal RS is incorrect for N consecutive times before increasing the next time interval. Such variations are also within the scope of the present invention.

Therefore, according to the method of the above firmware update step, the firmware update system shortens the time interval of the next update step after the current update step is successful. On the other hand, the firmware update system extends the time interval of the next update step after the current update step fails. In this way, the time interval of the next update step can be dynamically adjusted according to whether the current update step is successful or not, thereby shortening the time of the whole firmware update procedure or improving the success rate of the firmware update procedure.

In the following paragraphs, some embodiments of the firmware update procedure of the present invention are proposed. In each embodiment, the table contains a plurality of update steps, in which each update step is assigned a sequence number (i.e., the first, second, third . . . N^{th} this update step has occurred), and the system judges whether the update step is correct or not (where “O” stands for the read-back signal is correct, and “X” stands for the read-back signal is incorrect).

Table 1 is an example of firmware update according to the present invention. In the whole firmware update procedure, the update step begins with a short time interval (for example, 1 millisecond (ms), but not limited to this). Understandably, the shorter the time interval of the update step, the more likely it is to result in incorrect judgment (because the time interval is too short, it is not easy for data to be successfully written into the memory module). As can be seen from Table 1, every time the judgment is incorrect, the time interval of the next update step will be increased, and with the increase of the time interval, the probability of success will gradually increase. Take the following Table 1 as an example, when the time interval is 1 millisecond, the result is incorrect. Then the time interval is lengthened (for example, twice the previous time interval), that is, 2 milliseconds, and the result is still incorrect. Then retest at an interval of 4 milliseconds. After the test, the result is still incorrect. Then the test is carried out at an interval of 8 milliseconds, and the test result is correct. After that, the time interval of subsequent update steps is reduced. For example, the new time interval can be the average of the last incorrect time interval and the last correct time interval. For example, if the last incorrect time interval is set to T4 (see Table 1 below, T4 is, for example, 4 milliseconds) and the last correct time interval is set to T5 (see Table 1 below, T5 is, for example, 8 milliseconds), the next time interval can be set to (T4+T5)/2, so it can be 6 milliseconds (see Table 1, the time interval corresponding to the fifth update step is 6 milliseconds). And so on, and gradually reduce the time interval in the subsequent update steps. However, it is worth noting that when the difference between the time interval of a certain update step and the time interval of the previous update step is less than a set value (this set value can be decided by the developer), since further reductions in the update step time interval have minimal effect on the total firmware update time, the subsequent update step can use the same time interval as the previous one (i.e., the time interval remains unchanged). For example, in Table 1, the time interval has approached a stable value at 4.24 milliseconds, and the time interval will not continue to change thereafter.

TABLE 1

| | Number of update steps | | | | | | | | | |
|---|---|---|---|---|---|---|---|---|---|---|
| | 1 | 2 | 3 | 4 | 5 | 6 | 7 | 8 | 9 | 10 |
| Correct/ | X | X | X | ◯ | ◯ | ◯ | ◯ | ◯ | ◯ | ◯ |
| incorrect. | | | | | | | | | | |
| Time | 1 | 2 | 4 | 8 | 6 | 5 | 4.5 | 4.25 | 4.25 | 4.25 |
| interval (ms) | | | | | | | | | | |

Table 2 is another embodiment of the firmware update procedure of the present invention. Different from the previous embodiment, even if the time interval of the current update step has approached a stable value, it is still possible to determine that the read-back signal RS is incorrect in the subsequent update step. That is to say, even if the firmware update system has successfully updated multiple steps at the same time interval, it is not guaranteed that the time interval can be applied to all subsequent update steps, and it is still possible to find incorrect judgment in the subsequent update steps. At this time, it is still necessary to lengthen the time interval of the next update step. For example, in Table 2, the time intervals used in 8^{th}, 9^{th} and 10^{th} update steps are all 4.25 milliseconds (considered a stable time interval). However, at the 10th update step, the system determines that the read-signal back RS is incorrect. Therefore, the time interval is extended again in the 11^{th} update step. This variation is also within the scope of the present invention.

TABLE 2

| Number of update steps | 1 | 2 | 3 | 4 | 5 | 6 | 7 | 8 | 9 | 10 | 11 | 12 |
|---|---|---|---|---|---|---|---|---|---|---|---|---|
| Correct/incorrect. | X | X | X | ◯ | ◯ | ◯ | ◯ | ◯ | ◯ | X | ◯ | ◯ |
| Time interval (ms) | 1 | 2 | 4 | 8 | 6 | 5 | 4.5 | 4.25 | 4.25 | 4.25 | 8.5 | 6.37 |

Table 3 is another embodiment of the firmware update procedure of the present invention. Different from the previous embodiment, the update step starts from a long time interval (for example, 100 milliseconds, but not limited to this). When the system determines that the read-back signal RS is correct, the time interval of the next update step is reduced or maintained (for example, it is reduced to ½ of the previous time interval, or it remains unchanged when the time interval tends to be stable), otherwise, if the system determines that the read-back signal RS is incorrect, the time interval of the next update step is increased.

TABLE 3

| Number of update steps | 1 | 2 | 3 | 4 | 5 | 6 | 7 | 8 | 9 | 10 |
|---|---|---|---|---|---|---|---|---|---|---|
| Correct/incorrect. | ◯ | ◯ | ◯ | ◯ | ◯ | X | ◯ | ◯ | ◯ | ◯ |
| Time interval (ms) | 100 | 50 | 25 | 12.5 | 6.25 | 3.12 | 4.68 | 3.90 | 3.90 | 3.90 |

Table 4 is another embodiment of the firmware update procedure of the present invention. The update step of this embodiment also starts from a long time interval (for example, 100 milliseconds, but not limited to this). In addition, the time interval change rate can be increased or decreased during the firmware update procedure. For example, in the initial few update steps, the reduction ratio of the time interval can be increased. Take the following Table 4 as an example. Initially, a longer time interval (e.g., 100 milliseconds) can be used as the time interval for the first update step. The first few update steps are in a coarse adjustment mode. When the system determines that the read-back signal RS is correct, the proportion by which the next time interval is reduced is greater. For example, the next time interval is set to ¼ of the previous time interval. When the system determines that the read-back signal RS is incorrect, the system switches to a fine adjustment mode, that is, the rate at which the next time interval changes can be reduced. For example, if the time interval of the latest failure is set to T6 and the time interval of the latest success is set to T7, the time interval of the next time can be (T6+T7)/2. That is to say, this embodiment is characterized in that when the system is in the coarse adjustment mode, the change amplitude of the time interval will be larger, so that the stable time interval can be approached more quickly. After the system determines that the read-back signal RS is incorrect, it switches to the fine adjustment mode to adjust the time interval of each update step more finely.

TABLE 4

| Number of update steps | 1 | 2 | 3 | 4 | 5 | 6 | 7 | 8 | 9 | 10 |
|---|---|---|---|---|---|---|---|---|---|---|
| Correct/incorrect. | ◯ | ◯ | ◯ | X | X | ◯ | ◯ | ◯ | ◯ | ◯ |
| Time interval (ms) | 100 | 25 | 6.25 | 1.56 | 3.12 | 5.07 | 4.09 | 3.60 | 3.60 | 3.60 |

| | | |
|---|---|---|
| Mode | Coarse adjustment mode | Fine adjustment mode |

In other embodiments of the present invention, the length of the time interval or the increase/decrease ratio can also be changed according to other circumstances. For example, the connected memory performance feedback module 50 can detect the current memory usage performance, and the timing control module 40 can control the time interval according to the memory usage. For example, when the memory is running at a high speed, it may mean that many programs are being executed and occupy most memory performance. At this time, the priority of the firmware update procedure can be slowed down, or a longer time interval can be set during the firmware update procedure to improve the success rate of data writing. The above variations are also within the scope of the present invention.

In a word, the concept of the firmware update procedure of the present invention is to shorten or maintain the time interval of the next update step after the update step is successful, and to extend the time interval of the next update step if the update step fails. All the embodiments shown above follow the above concepts. It is worth noting that the data recorded in the above tables of the embodiments are only some examples of the present invention, but the present invention is not limited to this. That is to say, other firmware update procedures according to the concept of the firmware update procedure according to the present invention also belong to the scope of the present invention.

Based on the above description and drawings, an apparatus for controlling firmware update time interval is provided, the apparatus includes a sending module 10 for sending a plurality of data commands DC and a plurality of read-back commands RC, a judging module 30 for receiving a read-back signal RS after one of the data command DC and the corresponding read-back command RC were sent, and for judging whether the read-back signal RS is correct, and a timing control module 40, which adjusts a time interval between the subsequent data command DC and the read-back command RC according to the result of the judging module 30.

In some embodiments of the present invention, wherein if the read-back signal RS is correct, the time interval T2 between the data command DC and the read-back command RC is shorter or equal to the previous time interval T1 when the data command DC and the read-back command RC are sent next time (please refer to FIG. 3), and if the read-back signal RS is not correct, the time interval T3 between the data command DC and the read-back command RC is longer the previous time interval T1 when the data command DC and the read-back command RC are sent next time (please refer to FIG. 4).

In some embodiments of the present invention, wherein the plurality of data commands DC sent by the sending module 10 include a first data command (the N^{th} data command DC), and after the first data command is sent, a first read-back command (the N^{th} read-back command RC) is sent corresponding to the first data command, wherein the time interval between the first data command (the N^{th} data command DC) and the first read-back command (the N^{th} read-back command RC) is defined as a first time interval T1.

In some embodiments of the present invention, further comprising a memory module 20 for storing firmware data.

In some embodiments of the present invention, wherein after the sending module 10 sends one of the data commands DC, a plurality of bits of data are written into a segment address of the memory module 20, and after the sending module 10 sends the read-back command RC, the read-back command RC requests the bits of data stored in the same segment address in the memory module 20 to be sent back to the judging module 30.

In some embodiments of the present invention, wherein the method for judging whether the read-back signal RS is correct by the judging module 30 includes: defining the plurality of bits of data written in the memory module 20 as a first serial number after the sending module 10 sends the data command DC, after the sending module 10 sends the read-back command RC, the bit data sent back from the memory module 20 to the judging module 30 is defined as a second serial number, and comparing whether the first serial number and the second serial number are the same, if the first serial number and the second serial number are the same (including the same number of bits and/or the same bit address, or other comparison methods approved by the manufacturer), the read-back signal RS is judged to be correct, if the first serial number and the second serial number are not the same, the read-back signal RS is judged to be incorrect.

In some embodiments of the present invention, if the read-back signal RS is correct, then a second data command (the N+1^{th} data command DC) and a second read-back command (the N+1^{th} read-back command RC) corresponding to the second data command are subsequently sent, wherein the time interval between the second data command (the N+1^{th} data command DC) and the second read-back command (the N+1^{th} read-back command RC) is defined as a second time interval T2.

In some embodiments of the present invention, wherein the ratio of the second time interval T2 to the first time interval T1 is more than ½ and less than or equal to 1.

In some embodiments of the present invention, wherein when the difference between the first time interval T1 and the second time interval T2 is less than a set value, the ratio of the first time interval T1 to the second time interval T2 is 1 (As mentioned above, when the difference between T1 and T2 is less than a set value, it means that the amplitude of time interval reduction is not obvious, and T2 can be set equal to T1).

In some embodiments of the present invention, wherein if the read-back signal RS is incorrect, the first data command (the N^{th} data command DC) is re-sent and a third read-back command (the N^{th} read-back command RC) corresponding to the re-sent first data command are subsequently sent, wherein the time interval between the re-sent first data command (the N^{th} data command DC) and the third read-back command (the N^{th} read-back command RC) is defined as a third time interval T3.

In some embodiments of the present invention, wherein the ratio of the third time interval T3 to the first time interval T1 is greater than 1, and when the third time interval T3 is less than 50 seconds, the sending module 10 continuously sends the plurality of data commands DC and the plurality of read-back commands RC (As mentioned above, 50 seconds here is a maximum time interval set by the manufacturer, but the invention can also set the maximum time interval to other values).

In some embodiments of the present invention, wherein when the third time interval T3 is greater than 50 seconds, the sending module stops sending the data commands and the read-back commands, and the apparatus sends an update failure signal (As mentioned above, 50 seconds here is a maximum time interval set by the manufacturer, but the invention can also set the maximum time interval to other values).

In some embodiments of the present invention, further comprising a memory performance feedback module 50 for checking the usage performance percentage of the memory module 20 and controlling the timing control module 40 according to the usage performance percentage of the memory module 20.

In some embodiments of the present invention, wherein the timing control module 40 further comprises a coarse adjustment mode and a fine adjustment mode (please refer to Table 4), the time interval between the data command DC sent by the sending module 10 and the corresponding read-back command RC is defined as tn (i.e., T1), the time interval between the next data command sent by the sending module 10 and the next corresponding read-back command RC is defined as tn+1 (i.e., T2 or T3), and the difference between the time interval tn and the time interval tn+1 is defined as ΔT.

In some embodiments of the present invention, wherein when the timing control module 40 is in the coarse adjustment mode, the difference ΔT is greater than the difference ΔT when the timing control module 40 is in the fine adjustment mode (please refer to Table 4).

In some embodiments of the present invention, wherein the timing control module 40 is in the coarse adjustment mode, and the timing control module 40 is switched to the fine adjustment mode (as mentioned above, the apparatus can be switched to the coarse adjustment mode or the fine adjustment mode according to the memory usage).

The present invention further provides a method for controlling firmware update, the method includes the following steps: sending a first data command (the N^{th} data command DC), sending a first read-back command (the N^{th} read-back command RC) after a first time interval T1 to receive a read-back signal RS, judging whether that read-back signal RS is correct, when the read-back signal RS is correct, a second data command (the N+1^{th} data command DC) is subsequently sent, and a second read-back command (the N+1^{th} read-back command RC) is sent after a second time interval T2, wherein the second time interval T2 is less than or equal to the first time interval T1, when the read-back signal RS is incorrect, the first data command (the N^{th} data command DC) is re-sent subsequently, and a third read-back command (the N+1^{th} data command DC) is sent after a third time interval T3, wherein the third time interval T3 is greater than the first time interval T1.

In some embodiments of the present invention, wherein after sending the first data command (the N^{th} data command DC), a plurality of bits of data are written into a segment address of a memory module 20, and then after sending the first read-back command (the N^{th} read-back command RC), the bits of data stored in the segment address in the memory module 20 are requested to be returned.

In some embodiments of the present invention, wherein the method for judging whether the read-back signal is correct comprises: after sending the first data command (the N^{th} data command DC), defining the plurality of bits of data as a first serial number, after sending the first read-back command (the N^{th} read-back command RC), the bit data returned from the memory module 20 are defined as a second serial number, and comparing whether the first serial number and the second serial number are the same, if the first serial number and the second serial number are the same, the read-back signal RS is judged to be correct, if the first serial number and the second serial number are not the same, the read-back signal RS is judged to be incorrect.

In some embodiments of the present invention, wherein the ratio of the second time interval T2 to the first time interval T1 is greater than ½ and less than or equal to 1.

The present invention provides an apparatus for controlling the firmware update time interval and a firmware update method. The invention is characterized in that in the firmware update procedure, the time interval of the update step (that is, the time interval between sending a data command and sending a corresponding read-back command) is dynamically adjusted. More specifically, after the update step is successful, the time interval of the next update step is shortened or maintained, and if the update step fails, the time interval of the next update step is extended. By dynamically adjusting the time interval, the total time of firmware update procedure can be reduced and the success rate of firmware update procedure can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for controlling firmware update time interval, comprising:
a sending module for sending a plurality of data commands and a plurality of read-back commands;
a judging module for receiving a read-back signal after one of the data command and the corresponding read-back command were sent, and for judging whether the read-back signal is correct; and
a timing control module, which adjusts a time interval between the subsequent data command and the read-back command according to the result of the judging module.

2. The apparatus for controlling firmware update time interval according to claim 1, wherein if the read-back signal is correct, the time interval between the data command and the read-back command is shorter or equal to the previous time interval when the data command and the read-back command are sent next time, if the read-back signal is not correct, the time interval between the data command and the read-back command is longer the previous time interval when the data command and the read-back command are sent next time.

3. The apparatus for controlling firmware update time interval according to claim 2, wherein the plurality of data commands sent by the sending module include a first data command, and after the first data command is sent, a first read-back command is sent corresponding to the first data command, wherein the time interval between the first data command and the first read-back command is defined as a first time interval T1.

4. The apparatus for controlling firmware update time interval according to claim 3, further comprising a memory module for storing firmware data.

5. The apparatus for controlling firmware update time interval according to claim 4, wherein after the sending module sends one of the data commands, a plurality of bits of data are written into a segment address of the memory module, and after the sending module sends the read-back command, the read-back command requests the bits of data stored in the segment address in the memory module to be sent back to the judging module.

6. The apparatus for controlling firmware update time interval according to claim 5, wherein the method for judging whether the read-back signal is correct by the judging module comprises:
defining the plurality of bits of data written in the memory module as a first serial number after the sending module sends the data command;
after the sending module sends the read-back command, the bit data sent back from the memory module to the judging module is defined as a second serial number;
comparing whether the first serial number and the second serial number are the same, if the first serial number and the second serial number are the same, the read-back signal is judged to be correct, if the first serial number and the second serial number are not the same, the read-back signal is judged to be incorrect.

7. The apparatus for controlling firmware update time interval according to claim 3, if the read-back signal is correct, then a second data command and a second read-back command corresponding to the second data command are subsequently sent, wherein the time interval between the second data command and the second read-back command is defined as a second time interval T2.

8. The apparatus for controlling firmware update time interval according to claim 7, wherein the ratio of the second time interval T2 to the first time interval T1 is more than ½ and less than or equal to 1.

9. The apparatus for controlling firmware update time interval according to claim 7, wherein when the difference between the first time interval T1 and the second time interval T2 is less than a set value, the ratio of the first time interval T1 to the second time interval T2 is 1.

10. The apparatus for controlling firmware update time interval according to claim 3, wherein if the read-back signal is incorrect, the first data command is re-sent and a third read-back command corresponding to the re-sent first data command are subsequently sent, wherein the time interval between the re-sent first data command and the third read-back command is defined as a third time interval T3.

11. The apparatus for controlling firmware update time interval according to claim 10, wherein the ratio of the third time interval T3 to the first time interval T1 is greater than 1, and when the third time interval T3 is less than 50 seconds, the sending module continuously sends the plurality of data commands and the plurality of read-back commands.

12. The apparatus for controlling firmware update time interval according to claim 11, wherein when the third time interval T3 is greater than 50 seconds, the sending module stops sending the data commands and the read-back commands, and the apparatus sends an update failure signal.

13. The apparatus for controlling firmware update time interval according to claim 4, further comprising a memory performance feedback module for checking the usage performance percentage of the memory module and controlling the timing control module according to the usage performance percentage of the memory module.

14. The apparatus for controlling firmware update time interval according to claim 2, wherein the timing control module further comprises a coarse adjustment mode and a fine adjustment mode, the time interval between the data command sent by the sending module and the corresponding read-back command is defined as tn, the time interval between the next data command sent by the sending module and the next corresponding read-back command is defined as tn+1, and the difference between the time interval tn and the time interval tn+1 is defined as ΔT.

15. The apparatus for controlling firmware update time interval according to claim 14, wherein when the timing control module is in the coarse adjustment mode, the difference ΔT is greater than the difference ΔT when the timing control module is in the fine adjustment mode.

16. The apparatus for controlling firmware update time interval according to claim 14, wherein the timing control module is in the coarse adjustment mode, and the timing control module is switched to the fine adjustment mode.

17. A method for controlling firmware update, comprising the following steps:
sending a first data command;
sending a first read-back command after a first time interval T1 to receive a read-back signal;
judging whether that read-back signal is correct;
when the read-back signal is correct, a second data command is subsequently sent, and a second read-back command is sent after a second time interval T2, wherein the second time interval T2 is less than or equal to the first time interval T1; and
when the read-back signal is incorrect, the first data command is re-sent subsequently, and a third read-back command is sent after a third time interval T3, wherein the third time interval T3 is greater than the first time interval T1.

18. The method for controlling firmware update according to claim 17, wherein after sending the first data command, a plurality of bits of data are written into a segment address of a memory module, and then after sending the first read-back command, the bits of data stored in the segment address in the memory module are requested to be returned.

19. The method for controlling firmware update according to claim 18, wherein the method for judging whether the read-back signal is correct comprises:
after sending the first data command, defining the plurality of bits of data as a first serial number;
after sending the first read-back command, the bit data returned from the memory module are defined as a second serial number;
comparing whether the first serial number and the second serial number are the same, if the first serial number and the second serial number are the same, the read-back signal is judged to be correct, if the first serial number and the second serial number are not the same, the read-back signal is judged to be incorrect.

20. The method for controlling firmware update according to claim 17, wherein the ratio of the second time interval T2 to the first time interval T1 is greater than ½ and less than or equal to 1.
